(19) United States
(12) Patent Application Publication
(10) Pub. No.: US 2007/0011903 A1
(43) Pub. Date: Jan. 18, 2007

(54) Drying apparatus

(76) Inventor: Hung-Shen Chang, Taoyuan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/179,947

(22) Filed: Jul. 12, 2005

(51) Int. Cl. F26B 21/06; F26B 19/00

(52) U.S. Cl. 34/73; 34/93

(57) ABSTRACT

A drying apparatus includes a hollow main body having an inside defining a water collection zone located at a lower portion thereof, a heat convection zone located above the water collection zone, and a drying zone located above the heat convection zone for drying an article to be dried. Thus, the drying apparatus produces hot air that is formed by a heat convection effect so as to dry the article placed in the drying zone efficiently, thereby enhancing the drying effect of the drying apparatus. In addition, the pivotable covers are pivoted outward to open the drying zone to allow the solar rays directly entering the main body so as to dry the article placed in the drying zone by the solar rays.

### BACKGROUND OF THE INVENTION

1. Field of the Invention

The present invention relates to a drying apparatus, and more particularly to a drying apparatus for drying an article to be dried.

2. Description of the Related Art

A drying apparatus is used for drying an article (such as the towel, clothing or the like) to be dried. The conventional drying apparatus in accordance with the prior art was disclosed in the Taiwanese Patent Publication No. M243495, M249966 and M251102. The above-mentioned conventional drying apparatus usually comprises a heat source co-operating with a fan to dry the article to be heated. However, the air convection effect produced by the conventional drying apparatus is not sufficient, thereby decreasing the drying effect. In addition, the conventional drying apparatus cannot use the solar rays as its heat source, thereby limiting the versatility of the conventional drying apparatus.

### SUMMARY OF THE INVENTION

In accordance with the present invention, there is provided a drying apparatus, comprising a hollow main body having an inside defining a water collection zone located at a lower portion thereof, a heat convection zone located above the water collection zone, and a drying zone located above the heat convection zone for drying an article to be dried.

The primary objective of the present invention is to provide a drying apparatus having a better heat convection effect to dry an article to be dried.

Another objective of the present invention is to provide a drying apparatus, wherein the drying apparatus produces hot air that is formed by a heat convection effect so as to dry the article placed in the drying zone efficiently, thereby enhancing the drying effect of the drying apparatus.

A further objective of the present invention is to provide a drying apparatus, wherein the pivotable covers are pivoted outward relative to the main body to open the drying zone of the main body to allow the solar rays directly entering the main body so as to dry the article placed in the drying zone by the solar rays.

Further benefits and advantages of the present invention will become apparent after a careful reading of the detailed description with appropriate reference to the accompanying drawings.

### BRIEF DESCRIPTION OF THE DRAWINGS

FIG. 1 is a plan view of a drying apparatus in accordance with the preferred embodiment of the present invention; and

FIG. 2 is a plan view of a drying apparatus in accordance with another preferred embodiment of the present invention.

### DETAILED DESCRIPTION OF THE INVENTION

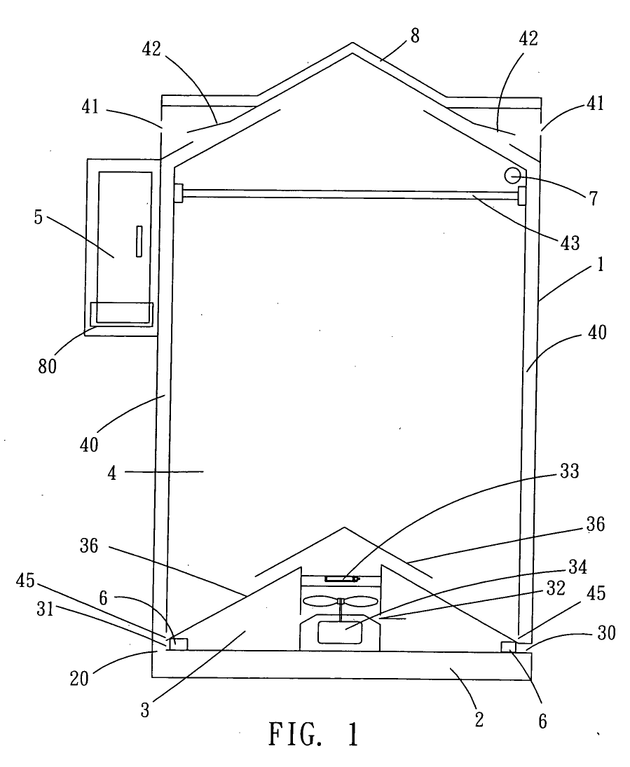

Referring to the drawings and initially to FIG. 1, a drying apparatus in accordance with the preferred embodiment of the present invention comprises a hollow main body 1 having an inside defining a water collection zone 2 located at a lower portion thereof, a heat convection zone 3 located above the water collection zone 2, and a drying zone 4 located above the heat convection zone 3 for drying an article (such as the towel, clothing or the like) to be dried.

The water collection zone 2 has a breach 20 communicating with the drying zone 4 so that the water produced from the dried article by dripping or condensing can pass through the breach 20 into the water collection zone 2.

The heat convection zone 3 has a first side having an air supply port 30 communicating with the ambient environment and a second side having an air convection port 31 communicating with the drying zone 4. The heat convection zone 3 has an upper portion having an air outlet port 32 communicating with the drying zone 4 for mounting a heat source generator 33 and an air driving fan 34 to produce convective hot air in the air outlet port 32.

The drying zone 4 has a periphery having a plurality of air convection ports 45, and the inside of the main body 1 has an air convection channel 40 surrounding the periphery of the drying zone 4 and communicating with the air convection ports 45 of the drying zone 4 and the breach 20 of the water collection zone 2. The drying zone 4 has an upper portion having a plurality of hot air drain ports 41. The drying zone 4 is provided with a plurality of regulating valves 42 to control the draining operation of the hot air drain ports 41, and a controller 5 to control the temperature of the drying zone 4.

When in use, the article to be dried is initially placed in the drying zone 4. Then, the air driving fan 34 is started to carry the ambient air through the air supply port 30 into the heat convection zone 3. Then, the air passes through the air outlet port 32 of the heat convection zone 3 to be heated by the heat source generator 33 to produce convective hot air which is carried into the drying zone 4 to dry the article placed in the drying zone 4. Then, the hot air with moisture in the drying zone 4 is drained outward from the hot air drain ports 41, and the regulating valves 42 are used to control the draining operation of the hot air drain ports 41.

At the same time, partial of the hot air in the drying zone 4 flows through the air convection channel 40 and the air convection ports 45 of the drying zone 4 and the air convection port 31 of the heat convection zone 3 to form a convection action (the cold air is lowered). In such a manner, the hot air in the air convection channel 40 is cooled by the ambient air by the heat convection action so as to produce convection cold air in the air convection channel 40. Thus, the hot air in the air convection channel 40 is condensed by the cooling action to form water drops which are dropped through the breach 20 into the water collection zone 2. Thus, the water produced from the dried article or produced during the condensing process falls down through the air convection channel 40 into the water collection zone 2.

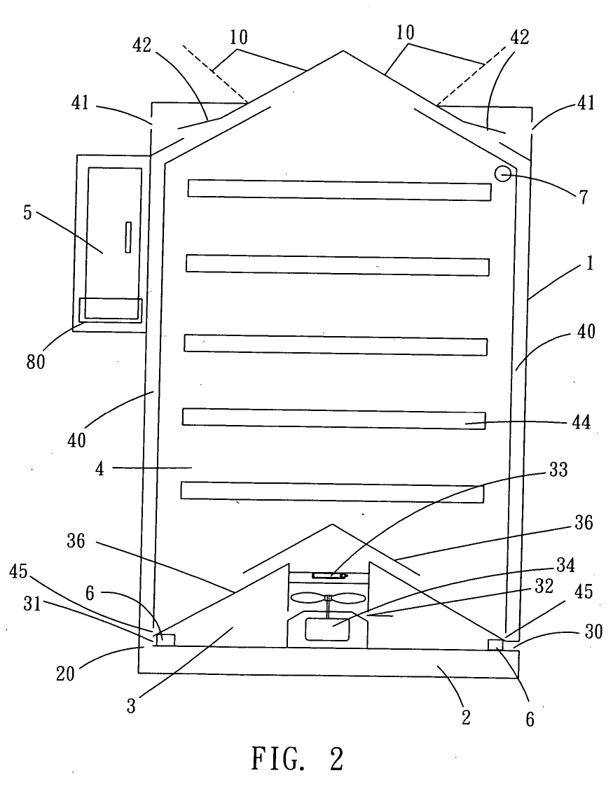

Referring to FIGS. 1 and 2, the main body 1 has a top provided with a plurality of pivotable covers 10. Thus, the pivotable covers 10 are pivoted outward relative to the main body 1 to open the drying zone 4 of the main body 1 to allow the solar rays directly entering the main body 1 so as to dry the article placed in the drying zone 4.

As shown in FIG. 1, the drying apparatus further comprises a support rod 43 mounted in the drying zone 4 of the main body 1 for hanging the article to be dried, a solar energy collector board 8 mounted on the top of the main body 1 to collect a solar energy and to convert the solar energy into an electrical energy, and a storage battery 80 mounted on the main body 1 and connected to the solar energy collector board 8 to store the electrical energy of the solar energy collector board 8 so as to provide an auxiliary electric power.

As shown in FIG. 2, the drying apparatus further comprises a plurality of support racks 44 mounted in the drying zone 4 of the main body 1 for hanging the article to be dried.

As shown in FIGS. 1 and 2, each of the air supply port 30 and the air convection port 31 of the heat convection zone 3 is provided with a filter 6 to filter impurities contained in the air. The drying apparatus further comprises an ultraviolet lamp 7 mounted in the drying zone 4 of the main body 1 to provide a sterilizing effect. The drying apparatus further comprises an oblique separation board 36 mounted in the main body 1 and located between the heat convection zone 3 and the drying zone 4 so that the water drops produced in the drying zone 4 during the drying process are introduced by the separation board 36 to flow through the air convection ports 45 and the air convection channel 40 of the drying zone 4 and through the breach 20 of the water collection zone 2 into the water collection zone 2.

Accordingly, the drying apparatus produces hot air that is formed by a heat convection effect so as to dry the article placed in the drying zone 4 efficiently, thereby enhancing the drying effect of the drying apparatus. In addition, the pivotable covers 10 are pivoted outward relative to the main body 1 to open the drying zone 4 of the main body 1 to allow the solar rays directly entering the main body 1 so as to dry the article placed in the drying zone 4 by the solar rays.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A drying apparatus, comprising:
a hollow main body having an inside defining a water collection zone located at a lower portion thereof, a heat convection zone located above the water collection zone, and a drying zone located above the heat convection zone for drying an article to be dried.

2. The drying apparatus in accordance with claim 1, wherein the water collection zone has a breach communicating with the drying zone so that water produced from the dried article can pass through the breach into the water collection zone.

3. The drying apparatus in accordance with claim 1, wherein the heat convection zone has a first side having an air supply port communicating with an ambient environment and a second side having an air convection port communicating with the drying zone.

4. The drying apparatus in accordance with claim 1, wherein the heat convection zone has an upper portion having an air outlet port communicating with the drying zone for mounting a heat source generator and an air driving fan to produce convective hot air in the air outlet port.

5. The drying apparatus in accordance with claim 1, wherein the drying zone has a periphery having a plurality of air convection ports, and the inside of the main body has an air convection channel surrounding the periphery of the drying zone and communicating with the air convection ports of the drying zone and a breach of the water collection zone.

6. The drying apparatus in accordance with claim 1, wherein the drying zone has an upper portion having a plurality of hot air drain ports.

7. The drying apparatus in accordance with claim 6, wherein the drying zone is provided with a plurality of regulating valves to control the draining operation of the hot air drain ports, and a controller to control the temperature of the drying zone.

8. The drying apparatus in accordance with claim 4, wherein the air driving fan is operated to carry an ambient air through the air supply port into the heat convection zone.

9. The drying apparatus in accordance with claim 8, wherein the air passes through the air outlet port of the heat convection zone to be heated by the heat source generator to produce convective hot air which is carried into the drying zone to dry the article placed in the drying zone.

10. The drying apparatus in accordance with claim 1, wherein the main body has a top provided with a plurality of pivotable covers.

11. The drying apparatus in accordance with claim 10, wherein the pivotable covers are pivoted outward relative to the main body to open the drying zone of the main body to allow the solar rays directly entering the main body so as to dry the article placed in the drying zone.

12. The drying apparatus in accordance with claim 1, further comprising a support rod mounted in the drying zone of the main body for hanging the article to be dried.

13. The drying apparatus in accordance with claim 1, further comprising a plurality of support racks mounted in the drying zone of the main body for hanging the article to be dried.

14. The drying apparatus in accordance with claim 1, further comprising a solar energy collector board mounted on the top of the main body to collect a solar energy and to convert the solar energy into an electrical energy.

15. The drying apparatus in accordance with claim 14, further comprising a storage battery mounted on the main body and connected to the solar energy collector board to store the electrical energy of the solar energy collector board so as to provide an auxiliary electric power.

16. The drying apparatus in accordance with claim 3, wherein each of the air supply port and the air convection port of the heat convection zone is provided with a filter to filter impurities contained in the air.

17. The drying apparatus in accordance with claim 1, further comprising an ultraviolet lamp mounted in the drying zone of the main body to provide a sterilizing effect.

18. The drying apparatus in accordance with claim 5, further comprising an oblique separation board mounted in the main body and located between the heat convection zone and the drying zone so that water produced in the drying zone is introduced by the separation board to flow through the air convection ports and the air convection channel of the drying zone into the water collection zone.
